(19) United States
(12) Patent Application Publication
(10) Pub. No.: US 2006/0089483 A1
(43) Pub. Date: Apr. 27, 2006

(54) Cyclic polycarbonates and copolycarbonates,production and use thereof

(76) Inventors: Rolf Wehrmann, Krefeld (DE); Helmut-Werner Heuer, Krefeld (DE); Claus-Ludolf Schultz, Krefeld (DE); Hans-R Kricheldorf, Hamburg (DE)

Correspondence Address: BAYER MATERIAL SCIENCE LLC, 100 BAYER ROAD, PITTSBURGH, PA, 15205, US

(21) Appl. No.: 10/542,341

(22) PCT Filed: Jan. 9, 2004
(86) PCT No.: PCT/EP04/00086

§ 371 Date: Dec. 14, 2005

(30) Foreign Application Priority Data
Jan. 21, 2003 (DE) 103 02 088.8

(51) Int. Cl. C08G 64/00

(52) U.S. Cl. 528/196

(57) ABSTRACT

A cyclic (co)polycarbonate resin is disclosed. The resin conforms structurally to general formulae (1a) or (1b), 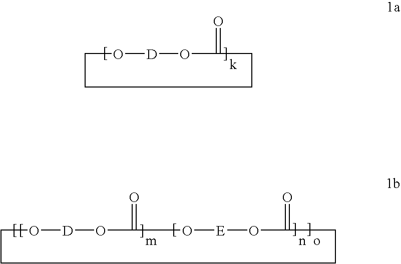 in which -D- and -E- independently denote an aromatic group having 6 to 40 C atoms, k stands for an integer from 1 to 4000 and m, n and o each independently of the other, stand for numbers from 1 to 4000. The resin is suitable for making a variety of useful articles.

The present invention provides cyclic polycarbonates and copolycarbonates, processes for their production and their use for the production of certain products as well as the products that can be obtained from them.

Aromatic polycarbonates belong to the class of technical thermoplastics. They are characterised by a combination of the technologically important properties transparency, resistance to thermoforming and toughness.

To obtain high-molecular linear polycarbonates by the interfacial polycondensation process, the alkali salts of bisphenols are reacted with phosgene in a two-phase mixture. The molecular weight can be controlled by the quantity of monophenols. These reactions produce almost exclusively linear polymers. This can be detected by terminal group analysis.

For the production of linear polycarbonates by the interfacial polycondensation process see for example H. Schnell, Chemistry and Physics of Polycarbonates, Polymer Reviews, Vol. 9, Interscience Publishers, New York 1964 p. 33 ff and Polymer Reviews, Vol. 10, “Condensation Polymers by Interfacial and Solution Methods”, Paul W. Morgan, Interscience Publishers, New York 1965, Ch. VIII, p. 325.

EP-A 0 827 948 discloses a process in which cyclic polycarbonates can be obtained on the basis of mixtures of special bischlorocarbonic acid esters. The publication of D. J. Brunelle, Polymer International 37 (1995) 179-186 discloses how cyclic oligomeric carbonates can be produced by hydrolysis/condensation reactions of aromatic bischloroformates.

Their improved flowability in comparison with linear polycarbonates means that cyclic polycarbonates are particularly interesting for applications in which a good flow of the polymer melt is required, i.e. for example injection moulding of complex structures.

However, the cyclic polycarbonates and processes for their production described previously in the prior art are unsatisfactory with regard to their production, or have the disadvantage that they cannot be obtained in a single step. Bischloroformic acid esters are first synthesised and these are then used as educts in a separate synthesis step.

The object was therefore to make available cyclic polycarbonates and processes for their production that avoid these disadvantages. This object is surprisingly achieved by the polycarbonates and production processes according to the invention, in which cyclic polycarbonates or copolycarbonates can be obtained in one step on the basis of bisphenols without producing or isolating bischloroformic acid esters.

The invention provides cyclic polycarbonates or copolycarbonates of the general formulae (1a) and (1b), 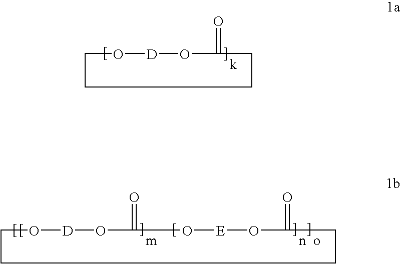
in which the group O-D-O or O-E-O stands for any diphenolate groups, in which -D- and -E- is an aromatic group having 6 to 40 C atoms, which may contain one or more aromatic or condensed aromatic nuclei, optionally containing heteroatoms and is optionally substituted with C₁-C₁₂-alkyl groups or halogen and may contain aliphatic groups, cycloaliphatic groups, aromatic nuclei or heteroatoms as bridging links and in which k stands for an integer from 1 to 4000, preferably from 2 to 2000, particularly preferably from 2 to 1000 and most preferably from 2 to 500 and in particular from 2 to 300, m, n and o each independently of the other stand for numbers from 1 to 4000, preferably from 1 to 2000 particularly preferably from 1 to 1000 and most preferably from 1 to 500 and in particular from 1 to 300.

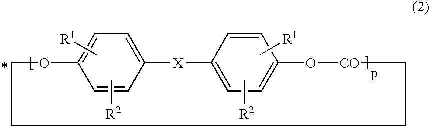

Preferred structural elements of the cyclic polycarbonates and copolycarbonates according to the invention are derived from general structures of the formula (2), wherein the bracket discloses the basic diphenolate groups, in which R1 and R2 independently of each other stand for H, linear or branched C₁-C₁₈ alkyl- or alkoxy groups, halogen such as Cl or Br or for an optionally substituted aryl or aralkyl group, preferably for H or linear or branched C₁-C₁₂ alkyl-, particularly preferably for H or C₁-C₈ alkyl groups and most preferably for H or methyl.

X stands for a single bond, a C₁- to C₆-alkylene-, C₂- to C₅-alkylidene-, C₅- to C₆-cycloalkylidene group, which may be substituted with C₁- to C₆-alkyl, preferably methyl- or ethyl groups or a C₆- to C₁₂-arylene group, which may optionally be condensed with other aromatic rings containing heteroatoms, wherein p stands for an integer from 1 to 4000, preferably from 2 to 2000, particularly preferably from 2 to 1000, most preferably from 2 to 500 and in particular from 2 to 300.

The diphenolate groups in the formulae (1a and b) and (2) are derived particularly preferably from the suitable phenols stated below.

Examples of the diphenols, which form the basis for the general formula (2) are hydroquinone, resorcinol, dihydroxybiphenyls, bis-(hydroxyphenyl)-alkanes, bis-(hydroxyphenyl)-cycloalkanes, bis-(hydroxyphenyl)-sulfides, bis-(hydroxyphenyl)-ethers, bis-(hydroxyphenyl)-ketones, bis-(hydroxyphenyl)-sulfones, bis-(hydroxyphenyl)-sulfoxides, α,α′-bis-(hydroxyphenyl)-diisopropyl benzenes as well as their core-alkylated and core-halogenated compounds, and also α,ω-bis-(hydroxyphenyl)-polysiloxanes.

Preferred diphenols are for example 4,4′-dihydroxy biphenyl (DOD), 2,2-bis-(4-hydroxyphenyl)-propane (bisphenol A), 1,1-bis-(4-hydroxyphenyl)-3,3,5-trimethylcyclohexane (bisphenol TMC), 1,1-bis-(4-hydroxyphenyl)-cyclohexane, 2,4-bis-(4-hydroxyphenyl)-2-methyl butane, 1,1-bis-(4-hydroxyphenyl)-1-phenyl ethane, 1,1-bis-(4-hydroxyphenyl)-p-diisopropyl benzene, 1,3-bis[2-(4-hydroxyphenyl)-2-propyl]-benzene (bisphenol M), 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 2,2-bis-(3,5-dichloro-4-hydroxyphenyl)-propane and 2,2-bis-(3,5-dibromo-4-hydroxyphenyl)-propane.

Particularly preferred diphenols are for example 2,2-bis-(4-hydroxyphenyl)-propane (bisphenol A), 4,4′-dihydroxybiphenyl (DOD), 1,3-bis[2-(4-hydroxyphenyl)-2-propyl]-benzene (bisphenol M), 2,2-bis-(3,5-dimethyl-4-hydroxyphenyl)-propane, 1,1-bis-(4-hydroxyphenyl)-1-phenyl ethane, 2,2-bis-(3,5-dichloro-4-hydroxyphenyl)-propane, 2,2-bis-(3,5-dibromo-4-hydroxyphenyl)-propane, 1,1-bis-(4-hydroxyphenyl)-cyclohexane and 1,1-bis-(4-hydroxyphenyl)-3,3,5-trimethyl-cyclohexane (bisphenol TMC).

2,2-bis-(4-hydroxyphenyl)-propane (bisphenol A), 4,4′-dihydroxybiphenyl (DOD), 1,3-bis[2-(4-hydroxyphenyl)-2-propyl]-benzene (bisphenol M) and 1,1-bis-(4-hydroxyphenyl)-3,3,5-trimethylcyclohexane (bisphenol TMC) are preferred most particularly.

The diphenols can be used both alone and in mixture with each other; both homopolycarbonates and copolycarbonates are included. The diphenols are known from the literature or can be produced by methods known from the literature (see e.g. H. J. Buysch et. al., Ullmann's Encyclopedia of Industrial Chemistry, VCH, New York 1991, 5th Ed., Vol. 19, p. 348).

Small quantities, preferably quantities of 0.05 to 2.0 mol. % in relation to the mols of diphenols used, of tri- or multifunctional compounds, in particular those having three or more than three phenolic hydroxy groups, may also be used as so-called branching agents. This of course results in deviations from the ideal formulae (1) and (2), which are given only by way of example, as this then produces branching structures.

Some of the compounds having three or more than three phenolic hydroxy groups that can be used are for example phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenyl methane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methylbenzyl)-4-methyl phenol, 2-(4-hydroxyphenyl)-2-(3,4-dihydroxyphenyl)-propane, hexa-[4-(4-hydroxyphenyl-isopropyl)-phenyl]-orthoterephthalic acid ester, tetra-[4-(4-hydroxyphenyl-isopropyl)-phenoxy]-methane, tetra-(4-hydroxyphenyl)-methane and 1,4-bis-(4′,4″-dihydroxytriphenyl)-methyl benzene.

Other possible branching agents are 2,4-dihydroxybenzoic acid, trimesic acid, cyanuric chloride and 3,3-bis-(3-methyl-4-hydroxyphenyl)-2-oxo-2,3-dihydroindol.

The present invention further provides a process for the production of cyclic polycarbonates and copolycarbonates of the formulae (1a) and (1b) characterised in that bisphenols are dissolved in aqueous alkaline solution and added drop-by-drop, whilst stirring, at the same time as a carbonate source optionally dissolved in a solvent, to a two-phase mixture of aqueous alkaline solution an organic solvent and a catalyst, preferably an amine compound.

The bisphenols are dissolved in an aqueous alkaline solution in concentrations of 0.05 to 15 wt. %, preferably 0.05 to 12 wt. %, particularly preferably 0.08 to 10 wt. % and most particularly 0.08 to 8 wt. %.

The term “aqueous alkaline solution” in the context of this invention, both as a solvent for the bisphenols and as a component of the two-phase mixture provided, stands for a solution consisting of water, in which at least one basic alkali- or earth alkali metal salt is dissolved. Hydroxides, in particular sodium and/or potassium hydroxides, are preferred. In principle, any concentration of salts can be used here, but the concentration is preferably 0.1 to 20 wt. %, particularly preferably 0.1 to 18 wt. %, most particularly preferably 0.2 to 15 wt. % and in particular 0.2 to 12 wt. %.

When using phosgene as a carbonate source, the volume ratio of aqueous alkaline solution to organic solvent is 5:95 to 95:5, preferably 20:80 to 80:20, particularly preferably 30:70 to 70:30 and most particularly preferably 40:60 to 60:40. The molar ratio of bisphenol to phosgene is less than 1:10, preferably less than 1:6, particularly preferably less than 1:4 and most particularly preferably less than 1:3. The concentration of the cyclic polycarbonates and copolycarbonates according to the invention in the organic phase is 0.1 to 20 wt. %, preferably 0.3 to 12 wt. %, particularly preferably 0.5 to 10 wt. %, and most particularly preferably 0.7 to 8 wt. %.

The concentration of the amine compound in relation to the quantity of bisphenol used is 0.1 to 10 mol. %, preferably 0.2 to 8 mol. %, particularly preferably 0.3 to 6 mol. % and most particularly preferably 0.4 to 5 mol. %.

When using phosgene and diphosgene, tetraalkyl ammonium salts are also suitable as catalysts and the suitable quantities of diphosgene are then calculated according to the phosgene equivalents.

When using triphosgene, tetraphenyl phosphonium chloride is particularly suitable as the catalyst and the suitable quantities of triphosgene are then calculated according to the phosgene equivalents.

Bisphenols are understood to mean the above-mentioned diphenols, in some cases containing proportions of the above-mentioned branching agents. The carbonate source is phosgene, diphosgene or triphosgene, preferably phosgene. If phosgene is used, a solvent may optionally be dispensed with and the phosgene can be introduced directly into the reaction mixture.

Tertiary amines such as triethyl amine or N-alkyl piperadine can be used as the catalyst. Trialkyl amines and 4-(dimethylamino)pyridine are suitable as catalysts. Triethyl amine, tripropyl amine, triisopropyl amine, tributyl amine, triisobutyl amine, N-methyl piperadine, N-ethyl piperadine and N-propyl piperadine are particularly suitable. Small quantities of catalyst are advantageous here for cyclising, and namely 0.2-25 mol. %, in particular 0.5-5 mol. % most particularly 0.8-3 mol. % (in relation to the quantity of diphenols).

Halogenated hydrocarbons such as methylene chloride and/or chlorobenzene, dichlorobenzene or trichlorobenzene or mixtures of these are possible organic solvents.

The reaction temperature may be −5° C. to 200° C., preferably 0° C. to 120° C., particularly preferably 0° C. to 100° C. and most particularly preferably 5° C. to 80° C.

The molecular weights Mw of the cyclic polycarbonates and copolycarbonates according to the invention are in the range of 600 to 1000000 g/mol, preferably of 600 to 500000 g/mol, particularly preferably of 600 to 250000 g/mol and most particularly preferably of 600 to 120000 g/mol and in particular of 600 to 80000 g/mol (determined by GPC and polycarbonate calibration).

Embodiments that use the parameters, compounds, definitions and explanations described as preferred, particularly preferred or most particularly preferred or preferably etc., are preferred, particularly preferred or most particularly preferred.

The parameters, compounds and explanations stated above generally or in preferred ranges may however also be combined with each other in any way, in other words between the relevant ranges and preferred ranges.

The cyclic polycarbonates and copolycarbonates according to the invention may be worked up in the known way and processed into any moulded bodies, for example by extrusion or injection moulding.

The cyclic polycarbonates and copolycarbonates according to the invention may be admixed into other aromatic polycarbonates and/or other aromatic polyester carbonates and/or other aromatic polyesters in the known way.

The conventional additives for these thermoplastics such as fillers, UV-stabilisers, thermostabilisers, antistatics and pigments may also be added to the cyclic polycarbonates and copolycarbonates according to the invention in the conventional quantities; the mould-release behaviour, the flow behaviour and/or the flame-resistance may optionally be improved by adding external mould release agents, flow agents and/or flame-retardants (e.g. alkyl- and aryl phosphites, -phosphates, -phosphanes, -low molecular carboxylic acid esters, halogen compounds, salts, chalk, quartz powder, glass- and carbon fibres, pigments and combinations of these. Such compounds are disclosed e.g. in WO 99/55772, p. 15-25 and in the corresponding chapters of the “Plastics Additives Handbook”, ed. Hans Zweifel, 5th edition 2000, Hanser Publishers, Munich).

The cyclic polycarbonates and copolycarbonates according to the invention, optionally in mixture with other thermoplastics and/or conventional additives, can be processed to produce any moulded bodies/extrudates and used wherever polycarbonates, polyester carbonates and polyesters that are already known are used. As a result of their profile of properties, they are suitable in particular as substrate materials for optical data storage devices such as e.g. CDs, CD-Rs, DVDs or DVD-Rs, but may also be used for example as films in the electrical sector, as moulded parts in vehicle construction and as panels for covers in the safety field. Other possible applications of the polycarbonates according to the invention are:
1. Safety screens which are known to be required in many parts of buildings, vehicles and aircraft, and as visors for helmets.
2. Production of films, in particular ski films.
3. Production of blow-moulded bodies (see for example U.S. Pat. No. 2,964,794), for example 1 to 5 gallon water bottles.
4. Production of transparent panels, in particular of cellular panels, for example as a covering for buildings such as stations, greenhouses and lighting units.
5. Production of optical data storage devices.
6. For the production of traffic light housings or traffic signs.
7. For the production of foamed materials (see for example DE-B 1 031 507).
8. For the production of threads and wire (see for example DE-B 1 137 167 and DE-A 1 785 137).
9. As translucent plastics with a glass-fibre content for lighting purposes (see for example DE-A 1 554 020).
10. As translucent plastics with a content of barium sulfate, titanium dioxide and/or zirconium oxide or organic polymeric acrylate rubbers (EP-A 634 445, EP-A 269324) for the production of transparent and light-diffusing moulded parts.
11. For the production of precision injection-moulded parts, such as for example lens mounts. Polycarbonates with a content of glass fibres, which optionally contain additionally approximately 1-10 wt. % MoS₂ in relation to the total weight, are used for this.
12. For the production of parts for optical instruments, in particular lenses for photographic and film cameras (see for example DE-A 2 701 173).
13. As a light transmission carrier, in particular as an optical waveguide (see for example EP-A 0 089 801).
14. As an electrical insulation material for electrical conductors and for plug casings and pin-and-socket connectors.
15. Production of mobile telephone cases with improved resistance to perfume, after-shave and skin perspiration.
16. Network interface drives.
17. As a carrier material for organic photoconductors.
18. For the production of lamps, e.g. headlights, so-called head-lamps, light diffusing discs or internal lenses.
19. For medical applications e.g. oxygenators, dialysis machines.
20. For food applications, such as e.g. bottles, cutlery and chocolate moulds.
21. For uses in the automotive field, where there may be contact with fuels and lubricants, such as for example bumpers, optionally in the form of suitable blends with ABS or suitable rubbers.
22. For sports equipment such as e.g. slalom poles or ski boot fastenings.
23. For household articles such as e.g. kitchen sinks and letter box cases.
24. For cases, such as e.g. electrical service cabinets.
25. Cases for electric toothbrushes and hairdryers.
26. Transparent washing machines—portholes with improved resistance to washing solutions.
27. Protective goggles, optical correcting glasses.
28. Lamp covers for kitchen appliances with improved resistance to kitchen vapours, particularly oil vapours.
29. Packaging films for medicines.
30. Chip boxes and chip carriers.
31. For other applications such as e.g. stable doors or animal cages.

The moulded bodies and extrudates made from the polymers according to the invention are also provided by this application.

The following examples are intended to illustrate the invention without, however, restricting it.

### EXAMPLES

### Example 1

27.4 g (120 mmol) bisphenol A and 28.8 g (720 mmol) NaOH are dissolved in 1000 ml water. This solution is added whilst stirring, at the same time as 23.74 g (240 mmol) phosgene, to a mixture consisting of 1400 ml dichloromethane, 2.4 g (40 mmol) NaOH, 400 ml water and 3.04 g (3 mmol) triethyl amine. During this process, the temperature is maintained at 19 to 21° C. by occasional cooling. The dropping-in time is about 1 hour. The organic phase is then separated off, washed with dilute phosphoric acid and then neutralised with water. After drying with sodium sulfate, the organic phase is concentrated in a vacuum and dried overnight in a vacuum drying cabinet at 80° C. Yield: 22.31 g.

Some of this is dissolved in methylene chloride and precipitated out with methanol. The deposit is drawn off and dried overnight in the vacuum drying cabinet at 80° C. Only BPA polycarbonate cycles (as Li adducts) are detected by MALDI-TOF. The following molar masses, amongst others, were detected: 769, 1023, 1277 and 1531 g/mol.

Cyclic copolycarbonates were produced in a similar way from the following bisphenols:

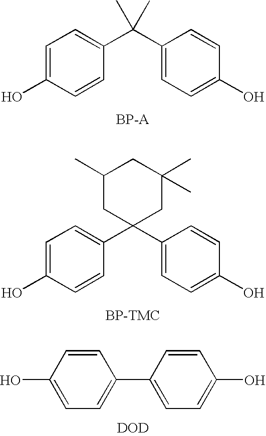

The quantity ratios (mol. %) given in the following table were used to produce the cyclic copolycarbonates:

| | BP-A | BP-TMC | DOD |
|---|---|---|---|
| Example 2 | 65 | 35 | — |
| Example 3 | 70 | — | 30 |

The resulting products were analysed by MALDI-TOF. In example 2, cycles of masses 1269, 1360 and 1442, amongst others, occur, which are cyclic copolycarbonates of BPA and BP-TMC with varying monomer ratios. In example 3, cycles of masses 1618, 1660, 1701 and 1744 occur, which are cyclic copolycarbonates of BPA and DOD with varying monomer ratios.

### Example 4

### Synthetic Cyclic Polycarbonates Using Diphosgene and Triethyl Amine as Catalyst

A solution of bisphenol A (20 mmol) and NaOH (120 mmol) in 200 ml water and a solution of diphosgene (20 mmol) in dry dichloromethane (200 ml) are added drop-by-drop, whilst stirring rapidly, to a mixture of 50 ml water (containing 1 nmol NaOH) and 150 ml CH₂Cl₂ (containing 0.5 mmol triethyl amine). This addition by drops should take ca 1 h and the temperature is maintained in the range 19-21° C. by occasional cooling with cold water. The organic phase is then separated off, washed twice with water and dried with a little sodium sulfate. The organic phase is then concentrated in a vacuum and the product is precipitated out with methanol. Yield 60-75%. The yield depends on the type of phase separation during the washing process and the quantity of sodium sulfate.

The MALDI-TOF mass spectrum shows the peaks of cycles up to the measurement limit at 18 kDa. Below 3 kDa only tiny peaks of linear chains with two OH terminal groups appear. The quantity of 2.5 mol. % triethyl amine relative to bisphenol A was determined as optimum for cycle formation.

### Example 5

### Synthesis of Cyclic Polycaibonates Using Diphosgene and Benzyl Triethyl Ammonium Chloride (TEBA-Cl) as Catalyst

This is carried out in the same way as example 2, however a solution of bisphenol A (20 mmol) TEBA-Cl (12 mmol) and NaOH (132 mmol) in 200 ml water is added drop-by-drop. Instead of triethyl amine, 10 mmol TEBA-Cl in 50 ml water is added whilst stirring. Yield 61%, inherent viscosity=2.72 dl/g (in CH₂Cl₂).

### Example 6

### Synthesis of Cyclic Polycarbonate with Triphosgene and Triethyl Amine as Catalyst

A solution of bisphenol A (21 mmol) and NaOH (125 mmol) in 150 ml water and a solution of triphosgene (14 mmol) in dry CH₂Cl₂ (150 ml) are added simultaneously, drop-by-drop, whilst stirring vigorously, to a mixture of CH₂Cl₂ (100 ml), water (100 ml) and triethyl amine (10 mmol). The addition by drops lasts 1 h, the temperature being maintained in the range 19-21° C. Finally, the reaction mixture is worked up as in example 1). Yield 71%, inherent viscosity=0.45 dl/g. In the MALDI-TOF mass spectrum (irrespective of catalyst quantity) only mass peaks of cycles can be seen up to the technical limit at ca 18 kDa.

### Example 7

### Synthesis of Cyclic Polycarbonates Using Diphosgene and Triethyl Amine as Catalyst

A solution of bisphenol A (20 mmol) and NaOH (120 mmol) in 200 ml water and a solution of disphosgene (20 mmol) in tr. Dichloromethane (200 ml) are added drop-by-drop, whilst stirring rapidly, to a mixture of 50 ml water (containing 1 nmol NaOH) and 150 ml CH₂Cl₂ (contains 0.5 mmol triethyl amine). This addition by drops should last ca 1 h and the temperature is maintained in the range 19-21° C. by occasional cooling with cold water. The organic phase is then separated off, washed twice with water and dried with a little sodium sulfate. The organic phase is then concentrated in a vacuum and the product is precipitated out with methanol. Yield 60-75%. The MALDI-TOF mass spectrum shows only the peaks of cycles up to the mass limit at 18 kDa.

### Example 8

### Synthesis of Cyclic Polycarbonates Using Diphosgene and Benzyl Triethyl Ammonium Chloride (TEBA-Cl) as Catalyst

This is carried out in the same way as example 2, however a solution of bisphenol A (20 mmol) TEBA-chloride (12 mmol) and NaOH (132 mmol) in 200 ml water is added drop-by-drop. Instead of triethyl amine, 10 mmol TEBA-Cl in 50 ml water is added whilst stirring. Yield 61%, inherent viscosity 2.72 dl/g (in CH₂Cl₂).

### Example 9

### Synthesis of Cyclic Polycarbonate with Triphosgene and Triethyl Amine as Catalyst

A solution of bisphenol A (21 mmol) and NaOH (125 mmol) in 150 ml water and a solution of triphosgene (14 mmol) in tr. CH₂Cl₂ (150 ml) are added simultaneously, drop-by-drop, whilst stirring vigorously, to a mixture of CH₂Cl₂ (100 ml), water (100 ml) and triethyl amine (10 mmol). The addition by drops should last ca 1 h, the temperature being maintained in the range 19-21° C. Finally, the reaction mixture is worked up as in example 1). Yield 71%, inherent viscosity=0.45 dl/g. In the MALDI-TOF mass spectrum (irrespective of the catalyst quantity) only mass peaks of cycles can be seen up to the technical limit at 18 kDa.

### Example 10

### Synthesis of Cyclic Polycarbonates Using Triphosgene and Tetraphenyl Phosphonium Chloride (Ph₄PCl)

Bisphenol A (24 mmol) and NaOH (140 mmol) are dissolved in 200 ml H₂O and cooled to +4/+5° C. Furthermore, a solution of triphosgene (14 mmol) in tr. CH₂Cl₂ (200 ml) is cooled to +4/+5° C. Ph₄PCl (12 mmol) is then added to the NaOH solution and both solutions are mixed with a high-speed mixer whilst cooling with ice. After 10 minutes a normal paddle mixer is used and mixing continues for a further 50 min without cooling. The charge is then worked up as in example 1). Yield 73%, inherent viscosity=0.76 dl/g.

The MALDI-TOF mass spectrum shows only small quantities of linear chains and predominantly cycles.

1-5. (canceled)

6. A cyclic (co)polycarbonate conforming structurally to general formulae (1a) or (1b), 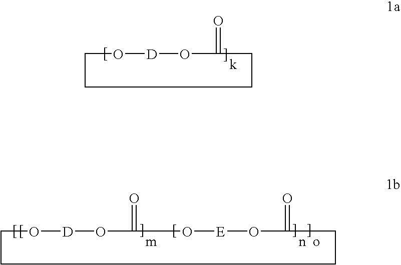
in which -D- and -E- independently denote an aromatic group having 6 to 40 C atoms, k stands for an integer from 1 to 4000 and m, n and o each independently of the other, stand for numbers from 1 to 4000.

7. The cyclic (co)polycarbonate of claim 6 wherein the aromatic group contains heteroatoms.

8. The cyclic (co)polycarbonate of claim 6 wherein the aromatic group is substituted with C₁-C₁₂-alkyl groups or halogen.

9. The cyclic (co)polycarbonate of claim 6 wherein the aromatic group contains at least one member selected from the group consisting of aliphatic group, cycloaliphatic group, aromatic nucleus and heteroatoms as a bridging link.

10. A cyclic (co)polycarbonate conforming structurally to the general formula (2) 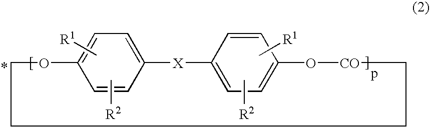
in which
R¹ and R² independently of each other denote H, linear or branched C₁-C₁₈ alkyl- or alkoxy-, halogen aryl- or aralkyl group, X stands for a single bond, a C₁- to C₆-alkylene, C₂- to C₅-alkylidene-, C₅- to C₆-cycloalkylidene group, or a C₆- to C₁₂-arylene group and p stands for an integer from 1 to 4000.

11. The cyclic (co)polycarbonate of claim 10 wherein the aryl or aralkyl group is substituted.

12. The cyclic (co)polycarbonate of claim 10 wherein the C₅- to C₆-cycloalkylidene group is substituted by C₁- to C-₆-alkyl.

13. The cyclic (co)polycarbonate of claim 10 wherein the C₆- to C₁₂-arylene group is condensed with aromatic rings containing other heteroatoms.

14. A process for the production of the (co)polycarbonate according to claim 6 comprising dissolving diphenols in an aqueous alkaline solution to obtain a first solution and adding the first solution drop-by-drop, whilst stirring, concurrent with a carbonate source to a two-phase mixture of an aqueous alkaline solution, an organic solvent and a catalyst.

15. The process of claim 14 wherein the carbonate source is dissolved in a solvent.

16. A molded article comprising the (co)polycarbonate of claim 6.
